(19) United States
(12) Patent Application Publication
(10) Pub. No.: US 2026/0269112 A1
(43) Pub. Date: Sep. 10, 2026

(54) A MAGNETIC DEVICE COMPRISING MAGNETIC PARTICLES

(71) Applicant: BIONAUT LABS LTD., Herzliya (IL)

(72) Inventor: Alex KISELYOV, Los Angeles, CA (US)

(73) Assignee: BIONAUT LABS LTD., Herzliya (IL)

(21) Appl. No.: 19/166,451

(22) PCT Filed: Mar. 21, 2024
(86) PCT No.: PCT/US2024/020957

§ 371 Date: Sep. 17, 2025

Related U.S. Application Data
(60) Provisional application No. 63/454,795, filed on Mar. 27, 2023.

(51) Int. Cl. H01F 7/02; H01F 1/06; H01F 1/11

(52) U.S. Cl. CPC H01F 7/0221; H01F 1/061; H01F 1/112

(57) ABSTRACT

Provided is a magnetic device comprising magnetic particles held in a matrix. The magnetic particles form visual pixels which rotate by means of an external field, changing the appearance of the device. The present invention provides a robust platform for a dynamic surface which can change its appearance under the influence of external stimuli. The platform provides a combination of mechanical and magnetic components: an external field (e.g., magnetic, electric) is used to rotate a plurality of magnetic particles held within a structure to make the surface appearance, of a collection of a plurality of magnetic particles, change. In one embodiment, when the external magnetic field is removed the appearance of the surface is maintained.

### FIELD OF THE INVENTION

The presently disclosed subject matter relates to magnetic devices comprising magnetic particles held in a matrix. The magnetic particles form visual pixels which rotate by means of an external field, changing the appearance of the device. Arrays and systems comprising devices and corresponding methods of operation and fabrication are also disclosed.

### BACKGROUND

The ability to modify a surface property (e.g., its appearance) of a material is of wide interest in industry and technology. External stimuli are often used in altering the properties of materials including but not limited to color and appearance of textiles and materials. For example, photochromic material changes their color and/or opacity in response to light exposure. Thermochromic materials change their appearance in response to different temperatures. One limitation of these materials is their inability to maintain the ‘on’ state i.e., once the external stimulus is removed the material returns to equilibrium or loses the desired organization.

Electrochromic materials are those which change color under the influence of an external electric field. Some electrochromic materials maintain their color even after the external field has been removed. However, electrochromic materials typically require the use of highly specific compounds with arduous chemical synthesis procedures. Such compounds are subject to significant degradation due to the sensitivity of the many compounds and functional groups that are employed therein.

The present invention provides a robust platform for a dynamic surface which can change its appearance under the influence of external stimuli. The platform provides a combination of mechanical and magnetic components: an external field (e.g., magnetic, electric) is used to rotate a plurality of magnetic particles held within a structure to make the surface appearance, of a collection of a plurality of magnetic particles, change. In one embodiment, when the external magnetic field is removed the appearance of the surface is maintained.

### SUMMARY

In one embodiment, the invention provides a magnetic device comprising:
a plurality of magnetic particles, the magnetic particles comprising a core and
a shell; and
a matrix comprising an upper plane and a lower plane each comprising an array of holes which are aligned between the upper plane and the lower plane;
   wherein the plurality of magnetic particles is secured in between the upper plane and the lower plane within the array of holes.

In one embodiment, the invention provides a magnetic device comprising:
a plurality of magnetic particles, the magnetic particles comprising a core and a shell; and
a matrix comprising an upper plane and a lower plane each comprising an array of placeholders which are aligned between the upper plane and the lower plane;
wherein the plurality of magnetic particles is secured in between the upper plane and the lower plane within the array of placeholders.

In one embodiment, the core has a shape selected from a list comprising: random shape, sphere, cylinder, tetrahedron, cube, octahedron, dodecahedron, icosahedron, cone, pyramid and rod or any combinations thereof. In one embodiment, the shell has a shape selected from a list comprising: random shape, sphere, cylinder, tetrahedron, cube, octahedron, dodecahedron, icosahedron, cone, pyramid and rod or any combinations thereof. In one embodiment, the core comprises between 1 to 99% of the volume of the magnetic particle. In one embodiment, the core comprises a magnetic material. In one embodiment, the core consists of a magnetic material. In one embodiment, the magnetic material comprises: permanent magnet, ferromagnet, iron, aluminum, cobalt, nickel, gadolinium, dysprosium, neodymium, samarium, terbium, molybdenum, copper, europium, holmium, ceramic magnet and alnico magnet or any combinations thereof. In one embodiment, the ceramic magnet comprises: strontium ferrite, barium ferrite, titanium ferrite, yttrium ferrite, yttrium iron garnet and lithium ferrite or any combination thereof. In one embodiment, the shell or the upper plane, or the lower plane, or any combination thereof, comprise a polymer. In one embodiment, the shell or the upper plane, or the lower plane, or any combination thereof, comprise a plastic. In one embodiment, the polymer is selected from: polyethylene (PE), polypropylene (PP), polyvinyl chloride (PVC), polystyrene (PS), polyethylene terephthalate (PET), polytetrafluoroethylene (PTFE), nylon, polycarbonate (PC), acrylonitrile-butadiene-styrene (ABS), polyurethane (PU), polyvinylidene fluoride (PVDF), perfluoroethylene (PFE), polymethyl methacrylate (PMMA), polyimide (PI), polyphenylene oxide (PPO), polyphenylene sulfide (PPS), polyetheretherketone (PEEK) and silicone or any combinations thereof. In one embodiment, the shell comprises a metal. In one embodiment, the metal is selected from: copper, titanium, tungsten, 416 stainless steel, nitinol, and an alloy or any combination thereof. In one embodiment, the size of at least one dimension of the magnetic particles ranges from between 0.01 to 5 mm. In one embodiment, the magnetic particles further comprise at least one coating disposed thereon. In one embodiment, the thickness of the upper plane, or the lower plane, or a combination thereof, ranges between 0.01 to 5 mm. In one embodiment, the upper plane, or the lower plane, or a combination thereof, is transparent, translucent, or opaque. In one embodiment, the upper plane, or the lower plane, or a combination thereof at least partially reflect, absorb, or polarize incident light. In one embodiment, the matrix comprises an array of placeholders. In one embodiment, a placeholder is selected from: a hole, an indentation, or a combination thereof. In one embodiment, the shape of the holes in the array of holes is selected from: random shape, circle, square, rectangle, triangle, rhombus, parallelogram, trapezoid, pentagon, hexagon, heptagon, octagon, nonagon, decagon, oval, ellipse, kite, elongated shape and diamond or any combination thereof. In one embodiment, the array of holes is positioned in a honeycomb structure. In one embodiment, where the placeholders are indentations, the shapes of the indentations are selected from: random shape, circle, square, rectangle, triangle, rhombus, parallelogram, trapezoid, pentagon, hexagon, heptagon, octagon, nonagon, decagon, oval, ellipse, kite, elongated shape and diamond or any combination thereof. In one embodiment, the distance between adjacent placeholders in the array of placeholders ranges between 0.01 to 10 mm. In one embodiment, the upper plane and the lower plane are curved. In one embodiment, the plurality of magnetic particles protrudes out of the upper plane or the lower plane or a combination thereof, by a percentage volume of the magnetic particles ranging between 1 to 50%. In one embodiment, the device further comprises spacers between the upper plane and the lower plane. In one embodiment, the device further comprises at least one color indicator at least partially disposed the surface of the core or the shell or a combination thereof. In one embodiment, the color indicator comprises a material which exhibits a property selected from: photochromic, thermochromic, electrochromic, fluorescent, iridescent, and phosphorescent or any combination thereof. In one embodiment, the plurality of magnetic particles is configured to rotate within the placeholders by application of an external field. The external field is selected from a magnetic field or an electric field, a combination thereof. In one embodiment, the device further comprises an encapsulation layer at least partially disposed on the upper plane or the lower plane or a combination thereof. In one embodiment, the device further comprises an adhesive layer at least partially disposed on the upper plane or the lower plane or a combination thereof. In one embodiment, the area of the matrix ranges between 1 cm² to 10 m². In one embodiment, the device further comprises a plurality of connectors configured to connect more than one of the matrix together. In one embodiment, the invention provides a magnetic device assembly comprising a plurality of the device disclosed herein wherein the plurality of connectors connects the plurality of devices.

In one embodiment, the invention provides a magnetic surface-manipulating system comprising:
a plurality of the devices disclosed herein, forming a connected structure;
at least one an external field source providing at least one external field; and a controller;
wherein the controller configures the at least one external field to control the rotation of magnetic particles.

In one embodiment, the at least one external field is selected from: magnetic, electric or a combination thereof. In one embodiment, the connected structure is flexible. In one embodiment, the at least one external field is provided by an electromagnet, or a permanent magnet or combinations thereof. In one embodiment, the at least one external field is provided by an array of electromagnets disposed on the upper plane or the lower plane, the array of electromagnets being in close proximity to the magnetic particles, wherein the electromagnets are configured to rotate the plurality of magnetic particles within the placeholders by application of an external magnetic field. In one embodiment, the terms “hole” and “placeholder” are used interchangeably in that they represent the holding site of a magnetic particle. In various embodiments the magnetic particle can rotate within the placeholder.

In some embodiments, the invention provides a method of operating the devices disclosed herein, the method comprising:
applying an external magnetic field in proximity to the plurality of magnetic particles, the plurality of magnetic particles further comprise at least one color indicator at least partially disposed the surface of the magnetic particles;
thereby rotating the plurality of magnetic particles; and
wherein the rotating causes the at least one color indicator to become viewable from above the upper plane or below the lower plane, or a combination thereof.

In one embodiment, the external magnetic field is removed, the orientation of the plurality of magnetic particles remains fixed.

In one embodiment, the invention provides a method of fabricating the devices disclosed herein, the method comprising:
fabricating the shell comprising a core cavity within the shell;
fabricating the core wherein the core is disposed within the core cavity, forming magnetic particles;
fabricating the matrix comprising the upper plane and the lower plane each comprising an array of placeholders;
disposing spacers between the upper plane and the lower plane; and
distributing the magnetic particles within the matrix wherein the magnetic particles are secured inside the array of placeholders.

In one embodiment, the fabricating of the shell comprises: imprinting, rolling, dripping, cutting, molding, and etching the shell to comprise the core cavity or any combinations thereof. In one embodiment, the shell comprises more than one section wherein the more than one section adheres to one another forming the shell comprising a core cavity.

In one embodiment, the adhering comprises means selected from: adhesion with an adhesive material, glue, pinning, welding, pressing, heat-pressing, and holding together with an encapsulation material. In one embodiment, the core is fabricated by the processes selected from: grinding, milling, mixing and melting, pressing, sintering, and machining or any combinations thereof. In one embodiment, the fabricating of the upper plane or the lower plane or a combination thereof comprises: 3D printing, molding, imprinting, rolling, drilling, cutting, etching, injection molding, blow molding, thermoforming, compression molding, transfer molding, casting, foaming, extrusion and rotational molding or any combinations thereof. In one embodiment, the fabricating of placeholders comprises: drilling, punching, milling, laser cutting, waterjet cutting, ultrasonic welding and cutting, electrical discharge machining, routing, plasma cutting, die cutting and etching or any combination thereof. In one embodiment, the distributing of magnetic particles comprises dispersing the magnetic particles on the upper plane or the lower plane and vibrating the upper plane or the lower plane. In one embodiment, the distributing comprises placing the magnetic particles in the placeholders by a pick-and-place system. In one embodiment, the devices disclosed herein further comprise an encapsulation at least partially disposed above the upper plane or below the lower plane or a combination thereof. In one embodiment, the device disclosed herein further comprises an adhesive material at least partially disposed above the upper plane or below the lower plane or a combination thereof.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a 2D schematic illustration of magnetic particles held between an upper and lower plane. FIG. 1A shows a spherical core and spherical shell; FIG. 1B shows a cylindrical core and cuboidal shell; FIG. 1C shows a cuboidal core and pentagonal shell; FIG. 1D shows a triangular core and hexagonal shell.

FIG. 2 is a 3D schematic illustration of various embodiments of magnetic particles comprising a core and a shell. FIG. 2A shows a cylindrical core and spherical shell; FIG. 2B shows a larger cylindrical core (than FIG. 2A) and a spherical shell; FIG. 2C shows a cuboidal core and spherical shell; FIG. 2D shows a spherical core and spherical shell.

FIG. 3 is a schematic illustration of the upper and lower plane architecture forming the matrix of the magnetic device. FIG. 3A shows the upper and lower plane covered with an array of holes and spacers holding the upper and lower plane in place. FIG. 3B shows the upper and lower plane holding spherical magnetic particles.

FIG. 4 shows the device assembly in an exploded rendering (FIG. 4A) and an assembled rendering (FIG. 4B).

FIG. 5 shows an array of modular structures (magnetic devices) of the present invention with an external magnet above the structure, changing the coloration of pixels within the array.

FIG. 6 depicts embodiments of a plurality of connected modular matrix units. FIG. 6A shows three connected modular matrix units formed as a 1×3 strip. FIG. 6B shows modular matrix units connected in an “S” shape.

FIG. 7 shows various examples of magnetic particles with different shades, colors or patterns that are visible on the surface. FIG. 7A shows a 2D representation of a sphere where one side is black and the other is white. FIG. 7B shows a 2D representation of a sphere where one quarter of the surface is black, on quarter is grey and the other two quarters are white. FIG. 7C shows a 2D representation of a pentagon where two sides are black, one side is grey, one side is white, and one side is patterned.

FIG. 8 shows a schematic of part of the magnetic surface-manipulating system, in particular of an array of external (electro)magnets coupled to one side of the device structure, in close enough proximity to the magnetic particles (not shown) so as to effect a rotational change in the orientation of corresponding magnetic particles in the array.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION

The present invention provides a platform for modifying a surface's appearance by means of an external field. Even though any external field can be used, the device is generally referred to as a “magnetic device”, “surface device” or “device”. In some embodiments, the external field is selected from: magnetic, electric or a combination thereof. Generally, the present invention utilizes magnetic particles held in a matrix which can rotate. For example, when the magnetic particle is colored black on one side and white on the other, when it rotates, an observer will notice a change in color on the surface. When a plurality of such magnetic particles are disposed on a surface, or in a matrix, and are exposed to a magnetic field, different regions the surface in which the magnetic particles are embedded will show different signals, such as different colors. Such an arrangement can be used to color a particular surface or to draw an outline of a particular image. In one embodiment, once the magnetic field is removed, the magnetic particles remain in place and the image is maintained on the surface.

In one embodiment, the magnetic devices described herein change their surface appearance e.g., their color, shading, patterning. As such, the surface device can be applied to textiles and the body of pre-existing structures e.g., on garments, vehicles or buildings for aesthetics. It can also have practical application in visual camouflage. For example, if an external system detects an incoming threat, the magnetic devices disposed on the surface of a vehicle can change its appearance, as a response, in the form of camouflage.

The magnetic device generally comprises a plurality of magnetic particles and a holding matrix. A single magnetic device can be connected to a plurality of magnetic devices, as modular units, to form larger magnetic device structures such as arrays or shaped structures. In various embodiments the magnetic particles comprise a core and a shell. In some embodiments, the core comprises magnetic material. As described herein, and in several embodiments, the holding matrix comprises an upper and a lower plane which each comprise an array of holes which are aligned between the upper and lower plane, wherein the plurality of magnetic particles is secured in between the upper and lower plane within the holes of the array of holes. In some embodiments, the holding matrix further comprises spacers disposed between the upper and lower plane. In one embodiment, the upper plane or lower plane, or combination thereof, comprise an array of holes. Other embodiments show that the holes can be used interchangeably with placeholders, such as indentations, according to the application requirements.

To enable rotation, magnetic particles and the matrix within which they are disposed, various conditions are considered to ensure that the magnetic particles can move but maintain their position once the external field is removed.

Some of the following considerations are disclosed:
The structure, shape and composition of components of the magnetic particles;
The matrix within which magnetic particles are disposed;
The friction between the magnetic particles and the matrix within which they are disposed;
The nature and application of the external magnetic field and its coupling to the magnetic particles.

The role of these factors will become apparent when various embodiments and examples are expanded upon.

### Magnetic Devices and Assemblies of Magnetic Devices

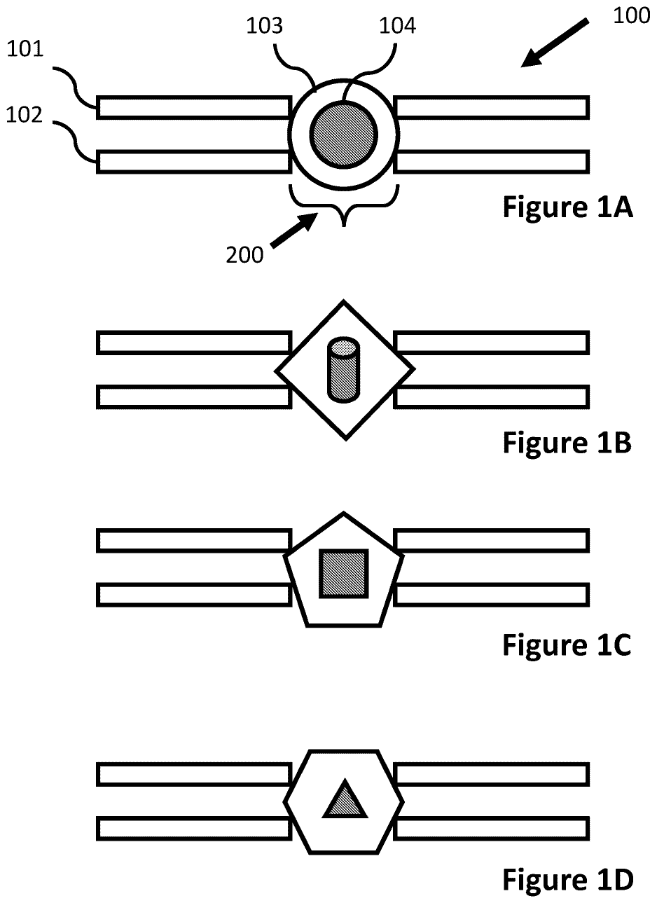

FIG. 1 shows four separate two-dimensional schematic depictions of (part of) a surface-device 100 of magnetic particles 200 held within an upper 101 and lower 102 layer. It should be noted that FIG. 1 is a simplified 2D representation, or cross-section, of a 3D structure. Furthermore, FIG. 1 only shows a single magnetic particle secured within a single hole, however, the magnetic device comprises many more which are not shown, for simplicity. Therefore, the specific 2D shapes and conformations depicted therein are for the purposes of example alone. For example, FIG. 1 show embodiments of a magnetic particle 200 comprising a core magnet 104 and a shell 103. In one embodiment, the term “magnetic particle” refers to any particle that is magnetic. In one embodiment, a magnetic particle comprises a core magnet and a shell. As used herein “core magnet” or “core” refers to any core that comprises magnetic material. Furthermore, the core is magnetic. In some embodiments, the terms “magnetic particle” and simply “particle” are used interchangeably. The core magnet 104 and the shell 103 are not limited to a particular 3D shape. In one embodiment, the core magnet 104 has a shape selected from a list comprising: random shape, sphere, cylinder, tetrahedron, cube, octahedron, dodecahedron, icosahedron, cone, pyramid and rod or any combinations thereof. In one embodiment, the core magnet 104 has the shape of a platonic object. In one embodiment, the shell 103 has a shape selected from a list comprising: random shape, sphere, cylinder, tetrahedron, cube, octahedron, dodecahedron, icosahedron, cone, pyramid and rod or any combinations thereof. In one embodiment, the shell 104 has the shape of a platonic object. In some embodiments, the shape of the core magnet 104 and the shell 103 are the same. In some embodiments, the shape of the core magnet 104 and the shell 103 are not the same. It is noted that the shapes do not need to be idealized representations of those shapes. In real world applications, some shapes made deviate from the idealized shapes that they were fabricated to be. As such, when referring to the shapes of certain objects, it is understood that any shape can also refer to its approximate shape or to shapes that are substantially similar. For example, the fabricated shape of a sphere may deviate from its idealized spherical shape by ±1%, ±5%, ±10%, ±20% or 50%. The term “random shape” refers to any unconventional shape that is not easily described by a standard geometry. Furthermore, and in some embodiments, the core or shell, or both, comprises an asymmetric shape. In other embodiments, the core or shell, or both comprise a symmetric shape.

In some embodiments, any combination of shapes for the core 104 and shell 103 can be used. FIG. 1A shows a round core (e.g., spherical) and a round shell (e.g., spherical). FIG. 1B shows a cylindrical core and a square shell (e.g., a cuboidal shell). FIG. 1C shows a square core (e.g., cuboidal) and a pentagonal shell. FIG. 1D shows a triangular core (e.g., pyramidal, conical) and a hexagonal shell. In one embodiment, the magnetic particle comprises more than one magnetic core. Correspondingly, and in one embodiment, the shell comprises more than one core cavity.

The volume of the core and the shell within a magnetic particle 200 can vary. In one embodiment, the core comprises between 1 to 99% of the volume of the magnetic particle 200. In one embodiment, the core comprises between 1 to 50% of the volume of the magnetic particle. In one embodiment, the core comprises between 20 to 40% of the volume of the magnetic particle. In one embodiment, the core comprises between 40 to 60% of the volume of the magnetic particle. In one embodiment, the core comprises between 60 to 80% of the volume of the magnetic particle. In one embodiment, the core comprises between 80 to 99% of the volume of the magnetic particle 200.

In some embodiments, the magnetic particle 200 only comprises a core magnet. In some embodiments, the magnetic particle 200 does not comprise a shell. In some embodiments, the magnetic particle comprises a core magnet and an encapsulation. For example, a core magnet can be encapsulated by a film, thin film, ink, paint or any other substance or coating that ensures that the magnetic particle 200 can rotate within the hole in which it is secured. In another embodiment the magnetic particle 200 comprises a coated core magnet. In another embodiment the magnetic particle consists of a coated core magnet.

The magnetic particle 200 can be comprised of various materials, examples of which are now disclosed. In some embodiments, the core magnet 104 comprises a magnetic material. As described herein “magnetic material” refers to any material that is magnetic. In some embodiments, the magnetic material comprises: a permanent magnet or a ferromagnet or a combination thereof. In one embodiment, the magnetic material comprises: a hard magnet or a soft magnet, or a combination thereof. Non-limiting examples of magnetic materials are those which comprise any of the following selected from: iron, aluminum, cobalt, nickel, gadolinium, dysprosium, neodymium, samarium, terbium, molybdenum, copper, europium, holmium, ceramic magnet and alnico magnet or any combinations thereof. Non-limiting examples of permanent magnets include: neodymium-iron-boron (NdFeB), samarium-cobalt (SmCo), alnico, ceramic (ferrite) and bonded magnets. In some embodiments, the magnetic material comprises an alloy. In one embodiment, the core comprises a ceramic magnet. Non-limiting examples of ceramic magnets include: strontium ferrite, barium ferrite, titanium ferrite, yttrium ferrite, yttrium iron garnet and lithium ferrite or any combination thereof. In one embodiment, the core comprises iron.

In a magnetic particle 200, the core magnet 104 is surrounded by the shell 103. The shell can be made of any material, some examples of which are now disclosed. In one embodiment, the shell comprises a polymer. In one embodiment, the shell comprises plastic. In one embodiment, the shell comprises a dielectric material. In another embodiment the shell consists of a polymer. In another embodiment the shell comprises more than one polymer. Non-limiting examples of polymers include: polyethylene (PE), polypropylene (PP), polyvinyl chloride (PVC), polystyrene (PS), polyethylene terephthalate (PET), polytetrafluoroethylene (PTFE), nylon, polycarbonate (PC), acrylonitrile-butadiene-styrene (ABS), polyurethane (PU), polyvinylidene fluoride (PVDF), perfluoroethylene (PFE), polymethyl methacrylate (PMMA), polyimide (PI), polyphenylene oxide (PPO), polyphenylene sulfide (PPS), polyetheretherketone (PEEK) and silicone or any combinations thereof. In some embodiments, the shell comprises: an epoxy, an encapsulation gel, paint, ink or acrylics.

The shell can also comprise a metal, such as a non-magnetic metal, a weakly magnetic metal or an alloy. Non-limiting examples of metals comprised within the shell include: copper, titanium, tungsten, 416 stainless steel, nitinol, and an alloy or any combination thereof.

In some embodiments, the shell further comprises at least one additional coating. In one embodiment, the magnetic particle further comprises at least one additional coating. For example, the additional coating may comprise an agent which decreases degradation in various ways. This may protect the surface and subsequently the magnetic particles disposed within. This additional agent may imbue the surface to be: heat resistant, weathering resistant, water resistant, light-bleaching resistant (i.e., lightfast), corrosion resistant, rust resistant, etc.

The size of the magnetic particle may vary according to various considerations which will become apparent. For example, the size of the magnetic particle will change according to its shape and corresponding hole it is placed in, the size and strength of the magnet disposed within, the thickness and material composition of the shell, magnetic shielding, material composition of the matrix (upper and lower planes), etc. For example, in an embodiment where the magnetic particle needs to rotate more freely the following may be used: a shell shape with fewer facets/sides, a low-friction material (for the shell and/or matrix), a stronger external magnet and a magnet that is better coupled to magnetic material, or any combination thereof. There are also differences with particles that are of different sizes. As will become apparent, the range of sizes of magnetic particles is from the micron to millimeter range. Thus, certain parameters like surface friction, which do not scale linearly with the radius of a particle, are adjusted for with each application. Furthermore, each magnetic particle shape, corresponding holes and contact with the matrix will vary, meaning that a single magnetic particle will have various points of contact between it and the matrix. As a general rule, greater contact between the magnetic particle and the matrix corresponds to greater friction. As such, the magnetic particle (e.g., shape, material, size) and matrix (e.g., hole shape, size, material) needs to be selected accordingly.

When referring to magnetic particles, as disclosed herein the “size” refers to at least one dimension of any of the components of the magnetic particles' shape. This includes the size of the core or the shell, or both. For example, if the size of a spherical magnetic particle is disclosed as being 1 mm this refers to the diameter of the core being 1 mm or the shell being 1 mm, or both being 1 mm. Thus, for a cylindrical core, the size refers to any of the dimensions e.g., the diameter of the cross-section or the cylinder length, or both.

In one embodiment, the size of a magnetic particle ranges from between 0.01 to 5 mm. In one embodiment, the size of a magnetic particle ranges from between 0.01 to 0.5 mm. In one embodiment, the size of a magnetic particle ranges from between 0.5 to 1 mm. In one embodiment, the size of a magnetic particle ranges from between 1 to 2 mm. In one embodiment, the size of a magnetic particle ranges from between 2 to 5 mm.

In embodiments described herein, a plurality of magnetic particles is used within a matrix. As such, the magnetic particles in the plurality of magnetic particles can be of a variety of sizes i.e., they are not necessarily all the same size.

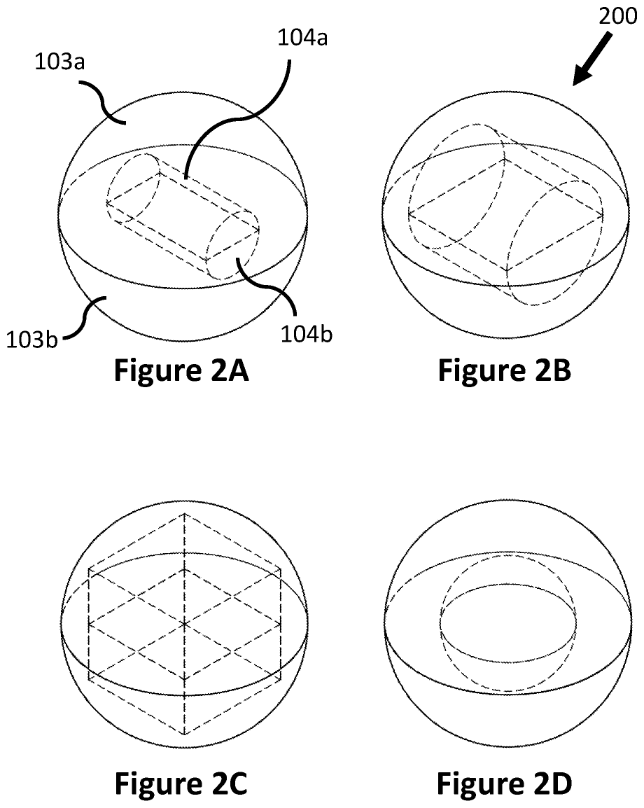

FIG. 2 shows some examples of 3D schematic illustrations of various embodiments of the magnetic particle 200 shell. For clarity, FIG. 2 does not show the magnetic cores themselves, but rather the cavity within which the core is disposed. As such, when referring to a core comprising magnetic material, the term “magnetic core” or simply “core” is used. Typically, the shape of the core cavity is the same as the core magnet that is disposed therein. As used herein the “core cavity” is the cavity comprised within the shell within which the core magnet is disposed. However, in some embodiments, the core cavity is different in shape from the core magnet. In various embodiments the magnetic particles 200 are an assembly of two halves of a shell: an upper shell 103a and a lower shell 103b. When the two shell halves 103a, 103b are brought together they leave a core cavity; the core, comprising magnetic material, being disposed therein (not shown in FIG. 2). The core cavity is comprised of an upper core cavity 104a and a lower core cavity 104b. In some embodiments, the core magnet (not shown) is immobilized within the core cavity 104a, 104b. In some embodiments, the core cavity 104a, 104b is off-center. Forming the magnetic particles by assembling the upper shell 103a and lower shell 103b is not a limiting means by which the magnetic core comes to be disposed within the shell structure, as will become apparent. For example, in some embodiments, the shell is formed in one step, forming one encapsulation material, not by the assembly of two shell halves. FIG. 2A shows a cylindrical core and spherical shell. FIG. 2B shows a larger cylindrical core than the one shown in FIG. 2A and a spherical shell. FIG. 2C shows a cuboidal core and spherical shell. FIG. 2D shows a spherical core and spherical shell.

In one embodiment, to ensure that a magnetic core 104 is secured within the core cavity 104a, 104b, an additional adhesive is used to at least partially fill the core cavity.

The degree to which the magnetic core needs to move within the core cavity will vary between applications. Thus, the volume which the magnetic core occupies within the core cavity may vary. In some embodiments, the magnetic core comprises between 1-100% of the volume of the core cavity. In some embodiments, the magnetic core comprises 100% of the volume of the core cavity. In some embodiments, the magnetic core comprises 95-100% of the volume of the core cavity. In some embodiments, the magnetic core comprises 80-100% of the volume of the core cavity. In some embodiments, the magnetic core comprises 50-100% of the volume of the core cavity. In some embodiments, the magnetic core comprises 50-90% of the volume of the core cavity. In some embodiments, the magnetic core comprises 10-50% of the volume of the core cavity. In some embodiments, the magnetic core comprises 1-10% of the volume of the core cavity.

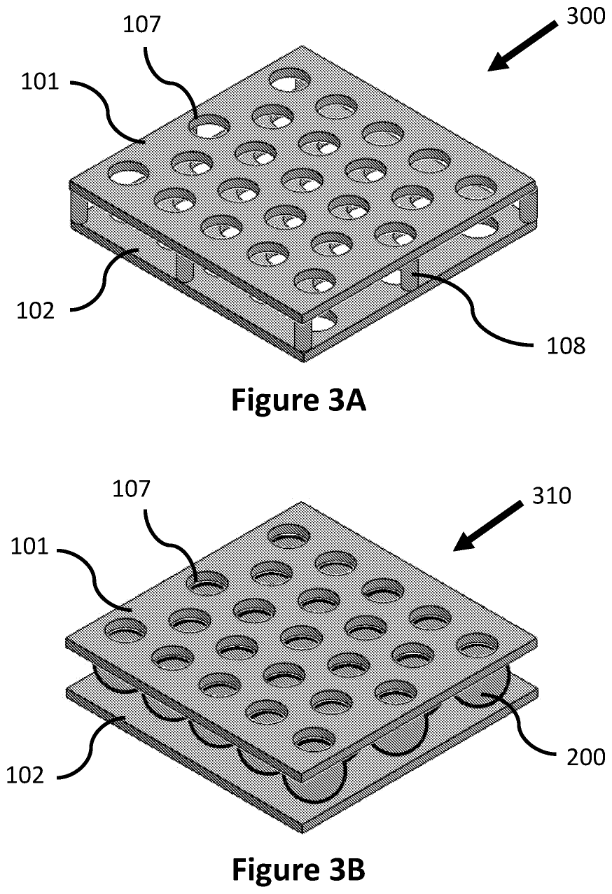

The magnetic particles 200 of the present invention are disposed within a holding matrix 300 forming a magnetic device 310, as shown in FIG. 3. As used herein “holding matrix” refers to a physical structure comprising an upper plane 101 and lower plane 102 where magnetic particles 200 are disposed therebetween. The terms “holding matrix” and “matrix” are used interchangeably. Typically, the holding matrix comprises an array of holes 107 on the upper plane 101 or the lower plane 102, or both, within which magnetic particles 200 are secured in place, but are able to rotate. As used herein, and in one embodiment, a “hole” refers to any structure that is an opening or gap in the upper and/or lower plane. In some embodiments, a “hole” refers to an indentation in the upper and/or lower plane but where there is no opening or gap. As such, and in some embodiments, the magnetic particles do not laterally move through the matrix (i.e., from hole to hole, or indentation to indentation). In a typical embodiment, the array of holes 107 on the upper plane 101 and the lower plane 102 are vertically aligned such that for each hole in the upper plane 101 there is a corresponding hole in the lower plane 102 which is directly below it.

In one embodiment, the array of holes 107 is only present on either the upper 101 or the lower plane 102. In this scenario, and in one embodiment, the plane without holes may comprise wells that vertically align with the holes in the other plane. For example, the upper plane has an array of holes whereas the lower plane has an array of wells that are vertically aligned with the array of holes in the upper plane (or vice versa). This arrangement may be preferable where one plane is designated for viewing (e.g., a pattern will be drawn to be view on the upper plane) whereas the other plane will be coupled to an adhesive material to stick the matrix onto a pre-existing surface.

In some embodiments, the holding matrix comprises an array of placeholders on the upper plane 101 or the lower plane 102, or both, within which magnetic particles 200 are secured in place, but are able to rotate. As defined herein, a “placeholder” is any structure that holds a magnetic particle in place, whilst allowing it to at least partially rotate. In some embodiments, the placeholder does not allow the magnetic particle to rotate. In some embodiments, the placeholders are holes, or structures that enable the magnetic particles to be secured in a particular position. For example, a placeholder may be an indentation in the upper or lower plane. In various embodiments, the term “placeholder” is used interchangeably with the term “hole” since they both serve the function of holding magnetic particles in place. For example, a holding matrix can comprise some placeholders that allow magnetic particles to rotate as well as placeholders that do not allow magnetic particles to rotate. As such, and in various embodiments, “arrays of holes” and “arrays of placeholders” can be used and understood interchangeably in that they assist in securing magnetic particles in place.

The indentation of these shapes can form high aspect ratio structures, as embedded within the upper and/or lower plane, or can form a low aspect ratio shape. For example, a 2D-circular indentation in the upper plane can take the form of a 2D-circular depression in the upper plane cut as a step. Alternatively, and in another embodiment, a 2D-circular indentation can take the form of a sloped-well forming a circular indentation or depression, rather than a sharp-edged (or ‘step’) 2D-circle in the upper and/or lower plane.

FIG. 3B shows magnetic particles 200 disposed within each corresponding pair of holes (between the upper 101 and lower plane 102). FIG. 3B depicts an embodiment wherein the magnetic particles 200 do not protrude from the upper 101 or lower plane 102 due to the holes 107 being too small (or the diameter of the magnetic particles 200 too large). In the case of FIG. 3B, were the holes 107 to have a larger diameter, or the magnetic particles 200 to have a smaller diameter, the magnetic particles 200 will begin to protrude through the holes via at least the upper 101 or lower plane 102 (or both). As such, the size of the holes 107 and magnetic particles 200 can be selected to control the extent of protrusion. In some embodiments, all the holes are occupied by magnetic particles. In one embodiment, between 10-100% of the holes are occupied by magnetic particles. In one embodiment, between 50-100% of the holes are occupied by magnetic particles. In one embodiment, between 80-100% of the holes are occupied by magnetic particles.

In some embodiments, the area of the matrix ranges between 1 cm² to 10 m². In some embodiments, the area of the matrix ranges between 1 cm² to 10 cm². In some embodiments, the area of the matrix ranges between 10 cm² to 100 cm². As will become apparent, a plurality of matrices can be connected together in an assembly, such that the area of an assembly is much greater than the area of its component parts.

In some embodiments, the magnetic particles protrude out of the upper plane 101 or the lower plane 102, or a combination thereof, by a percentage volume of the magnetic particles ranging between 1 to 50%. In some embodiments, the protrusion ranges between 1 to 5%. In some embodiments, the protrusion ranges between 5 to 10%. In some embodiments, the protrusion ranges between 10 to 20%. In some embodiments, the protrusion ranges between 20 to 40%. In some embodiments, the protrusion ranges between 40 to 50%.

In some embodiments, the holding matrix 300 further comprises spacers 108 (shown in FIG. 3A but not, for convenience, in FIG. 3B). These spacers 108 maintain a constant separation between the upper 101 and lower plane 102. In some embodiments, the magnetic particle 200 protrudes from the holes of the holding matrix 300, on either the upper plane 101 or lower plane 102, or both. In some embodiments, the size of the holes in the array of holes 107 on the upper plane 101 is different from the size of the holes in the array of holes in the lower plane 102.

In some embodiments, the holding matrix 300 comprises the following components: an upper plane 101, a lower plane 102 and a plurality of spacers 108. In one embodiment, at least one of the components of the matrix comprises a polymer. In one embodiment, at least one of the components of the matrix comprises plastic. In some embodiments, the polymer is selected from a list comprising: polyethylene (PE), polypropylene (PP), polyvinyl chloride (PVC), polystyrene (PS), polyethylene terephthalate (PET), polytetrafluoroethylene (PTFE), nylon, polycarbonate (PC), acrylonitrile-butadiene-styrene (ABS), polyurethane (PU), polyvinylidene fluoride (PVDF), perfluoroethylene (PFE), polymethyl methacrylate (PMMA), polyimide (PI), polyphenylene oxide (PPO), polyphenylene sulfide (PPS), polyetheretherketone (PEEK) and silicone or any combinations thereof. In one embodiment, at least one of the components of the matrix comprises glass or metal. In one embodiment, at least one component of the matrix comprises: ceramic, metal/metal alloy, films, biofilms, or any combinations thereof.

The thickness of the upper 101 and lower planes 102 can be the same or different. The upper 101 or lower plane 102 are also referred to herein as “planes”. In one embodiment, the thickness of a plane ranges between 0.01 to 5 mm. In one embodiment, the thickness of a plane ranges between 0.01 to 1 mm. In one embodiment, the thickness of a plane ranges between 0.01 to 0.5 mm. In one embodiment, the thickness of a plane ranges between 1 to 2 mm. In one embodiment, the thickness of a plane ranges between 2 to 5 mm.

The optical properties of the upper 101 and lower planes 102 can be customized for various applications. In some embodiments, the upper 101 or lower plane 102, or a combination thereof, is transparent, translucent, or opaque. In various embodiments, the surface of the upper 101 or lower plane 102, or both, is patterned and/or colored. In some embodiments, the upper 101 or lower plane 102, or both, at least partially reflect, absorb or polarize incident light.

As used herein, and in some embodiments, “hole” refers to any opening in a plane, not limited to being circular in shape. In some embodiments, a “hole” refers to something within which a magnetic particle is secured. For example, a hole can be an opening, or a trough or well (i.e., not an opening) in the upper or lower plane. As will become apparent, holes are analogous to pixels in that the magnetic particles disposed therein appear to change color upon rotation within the hole, as viewed from one side of the holding matrix. In some embodiments, the shape of holes in the array of holes 107 is selected from: random shape, circle, square, rectangle, triangle, rhombus, parallelogram, trapezoid, pentagon, hexagon, heptagon, octagon, nonagon, decagon, oval, ellipse, kite, elongated shape and diamond or any combination thereof. In one embodiment, the elongated shape is a line or bar. As such, different portions of the holding matrix may have holes of different shapes. The positioning of the holes can be uniform or non-uniform. In one embodiment, the holes within the array of holes are positioned in a honeycomb (hexagonal) structure, as shown in FIG. 3A. In some embodiments, the array of holes comprises any of the following 2D tiling arrangements: periodic tiling, regular polygon tiling, square packing, hexagonal (honeycomb), triangular packing, pentagon tiling, rhombic tiling, trihexagonal tiling, octagon tiling, dodecagon tiling and Penrose tiling (non-periodic) or any combinations thereof. In some embodiments, the 2D tiling arrangement of the holes comprises a k-uniform tiling. Examples of k-uniform tilings include: 1-uniform, 2-uniform, 3-uniform, 4-uniform 5-uniform and 6-uniform.

In some embodiments, the holes are positioned such that they form an image on the surface of the magnetic device. For example, to obtain an image of a stick-figure on a surface, a plurality of holes can be placed, e.g., on the upper plane, in the shape of a stick figure. When an external magnet is brought in close proximity to the plurality of holes that form a stick figure, the stick figure will change color.

In one embodiment, the holes comprise elongated structures. In some embodiments, more than one magnetic particle is comprised within a hole. For example, a hole is the shape of a linear elongated structure. In such an embodiment, a plurality of magnetic particles can be placed along the elongated hole structure such that they can move along it, like a track. In this example, the magnetic particles can rotate and also move laterally and longitudinally, depending on the shape of the hole.

The principle of a flat tiling of holes can be extended to uniform tilings in a hyperbolic plane. As such, the holding matrix can be made flexible and/or comprise 3D shapes, such as bumps, hills and troughs. The array of holes that preside on such a 3D structure can follow a hyperbolic geometry and include any of the following tiling geometries: regular, truncated, quasiregular, semiregular and omnitruncated.

Although the distance between holes may be as close as possible without hindering the motion of adjacent magnetic particles. However, holes may be dispersed at various distances. In some embodiments, the distance between adjacent holes ranges between 0.01 to 10 mm. In some embodiments, the distance between adjacent holes ranges between 0.01 to 5 mm. In some embodiments, the distance between adjacent holes ranges between 0.01 to 1 mm. In some embodiments, the distance between adjacent holes ranges between 0.01 to 0.5 mm. In some embodiments, the distance between adjacent holes ranges between 0.1 to 0.5 mm. In some embodiments, the distance between adjacent holes ranges between 0.5 to 1 mm. In some embodiments, the distance between adjacent holes ranges between 1 to 2 mm. In some embodiments, the distance between adjacent holes ranges between 2 to 5 mm.

The holding matrix 300 is a versatile platform which can hold magnetic particles. As such, it can be incorporated on various pre-existing surfaces and even shaped according to the surface upon which it is disposed. In some embodiments, the holding matrix 300 is flexible. In other embodiments the holding matrix 300 is curved. For example, the holding matrix can be shaped to be disposed upon the body of a vehicle. In some embodiments, the holding matrix is pressed or shaped against the surface of a pre-existing structure, without any gaps between it and the pre-existing structure i.e., the surfaces are level with each other (or ‘flush’). As such, and in some embodiments, the holding matrix can further comprise an adhesive layer to couple it to any pre-existing surface or body. For example, on the body of a vehicle, building or textile.

In some embodiments, one plane is more curved than the other plane and the size of the magnetic particles changes across the holding matrix to fit across the gap between the upper and lower plane.

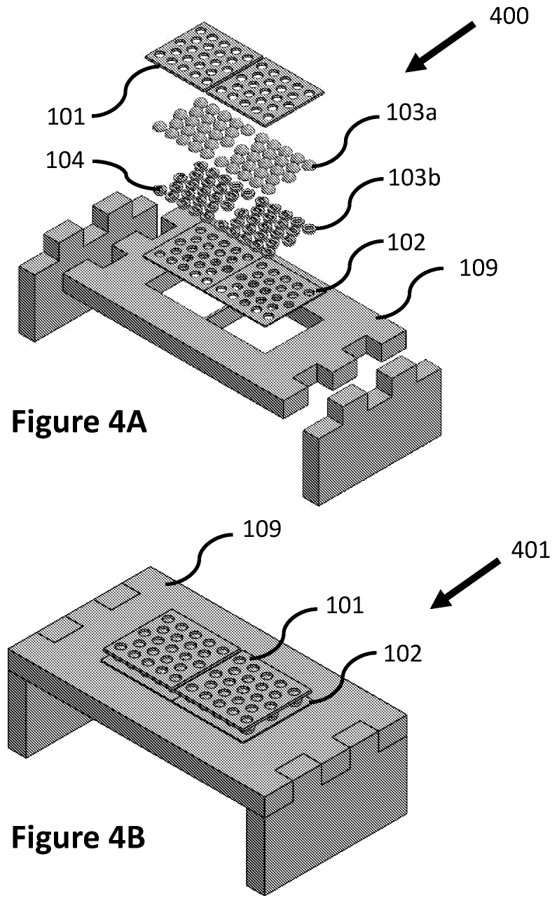

FIG. 4 shows 3D representations of the magnetic device. FIG. 4A shows a 3D exploded rendering 400 of the magnetic device. The upper 101 and lower planes 102 are held on a supporting structure 109. Also shown is the upper shell 103a and lower shell 103b within which the magnetic core 104 is disposed. FIG. 4B shows an assembled rendering 401 of the magnetic device comprising the upper plane 101, lower plane 102 and supporting structure 109.

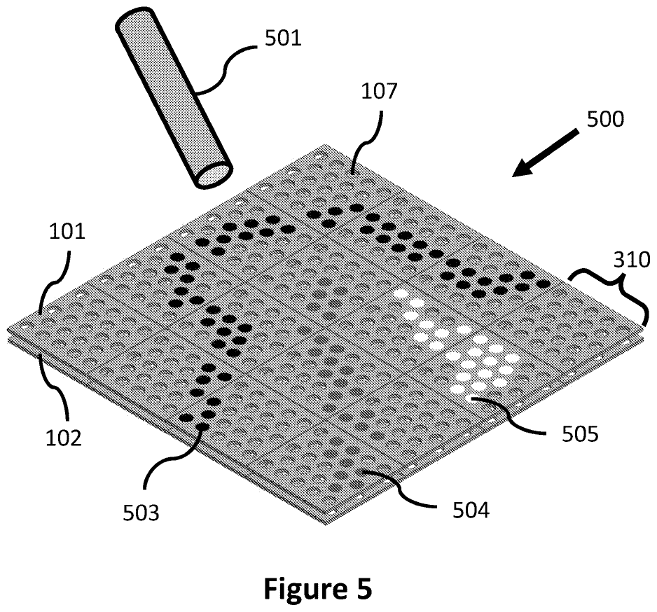

The magnetic device can comprise modular units, which are connected to one another to form larger structures. The modular units can be of different sizes. FIG. 5 shows an array 500 of magnetic devices 310 (e.g., a magnetic device assembly) whereby the appearance of black 503, grey 504 and white 505 pixels on the surface are controlled and manipulated by an external field 501 e.g., an external magnet (or electric field). The magnetic particles 200 themselves are not shown in FIG. 5, although various shades (black, grey, white) are shown, which represent the coloration/shading of different sides of the magnetic particles 200 as viewed from the top. The plurality of magnetic particles 200 are configured to rotate within the holes by application of an external field e.g., magnetic field. For example, FIG. 5 could represent a plurality of magnetic particles which are spheres which have a third of its surface colored black, one third grey and one third white. In such an example, depending on the orientation of the magnetic sphere, different shades, colors or patterns will be visible when viewing the upper plane (in this case: black, grey or white). As such, the magnetic particles act as pixels of an image in the array 500; one hole corresponding to one pixel. If the size of pixels is reduced and the pixels are closely packed, the ability to form high resolution images on the array 500 increases. In some embodiments, at least one of the magnetic particles disposed within the array 500 is a different shape from the other magnetic particles in the array. Thus, any combination of magnetic particles (i.e., of varying shape, core/shell materials, etc.) and holes can be used across the array 500.

The plurality of magnetic devices 310 are held together by connectors. Non-limiting examples of connectors are selected from: physical connection clips, snap-fit connectors, interlocking connectors, screw connections, clamps, rivet connectors, adhesive and springs or any combinations thereof. As such, once a plurality of magnetic devices are connected, they form a magnetic device assembly. As used herein a “magnetic device assembly” refers to more than two magnetic devices that are connected together. In some embodiments, “magnetic device assembly”, “device array” and “array” are used interchangeably. In other embodiments the assembly is referred to as a “connected structure” since the connecting of modular units need not be in an array, but rather in any connected structure, forming any shape.

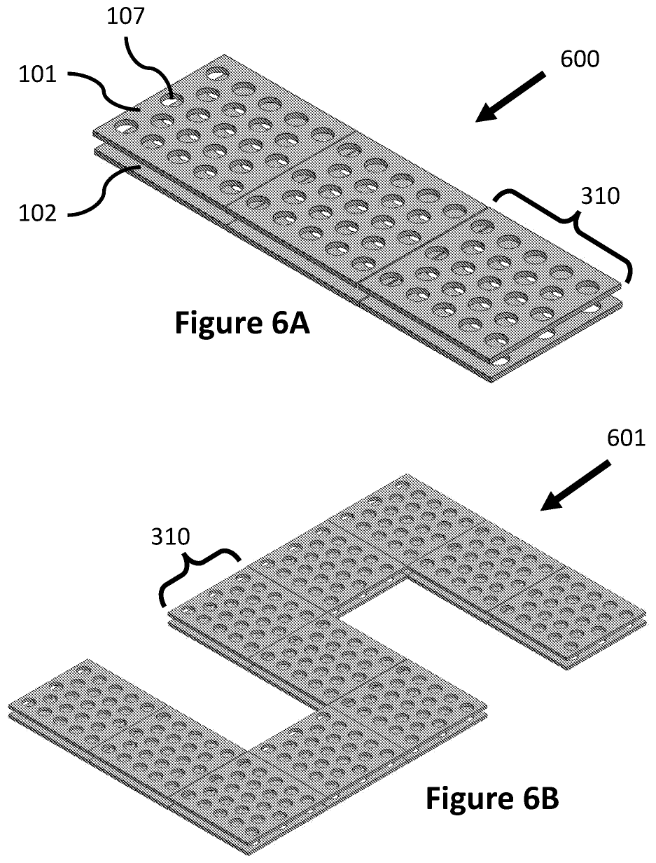

FIG. 6 shows two examples of magnetic devices 310 connected together to form various shapes. FIG. 6A shows a magnetic device strip 600 comprising an upper 101 and lower 102 plane, both comprising an array of holes 107 (magnetic particles are not shown, for convenience). In principle any number of magnetic devices 310 can be connected together forming a magnetic strip 600. In some embodiments, the length of the magnetic strip ranges between 1 cm to 100 m. In some embodiments, the length of the magnetic strip ranges between 1 to 10 cm. In some embodiments, the length of the magnetic strip ranges between 10 cm to 1 m. In some embodiments, the length of the magnetic strip ranges between 1 to 10 m. In some embodiments, the length of the magnetic strip ranges between 10 to 50 m. In some embodiments, the length of the magnetic strip ranges between 50 to 100 m.

FIG. 6B shows a plurality of magnetic devices 310 connected together forming an S-shaped structure 601. The shape and complexity of the patterns formed by connecting a plurality of magnetic devices 310 together is not limited to the examples provided herein. Furthermore, since the magnetic devices can be curved and flexible, the magnetic devices 310 can be connected together in 3D arrangements i.e., ones that are not strictly limited to the 2D plane, in some embodiments. In some embodiments, the magnetic devices form a 3D network.

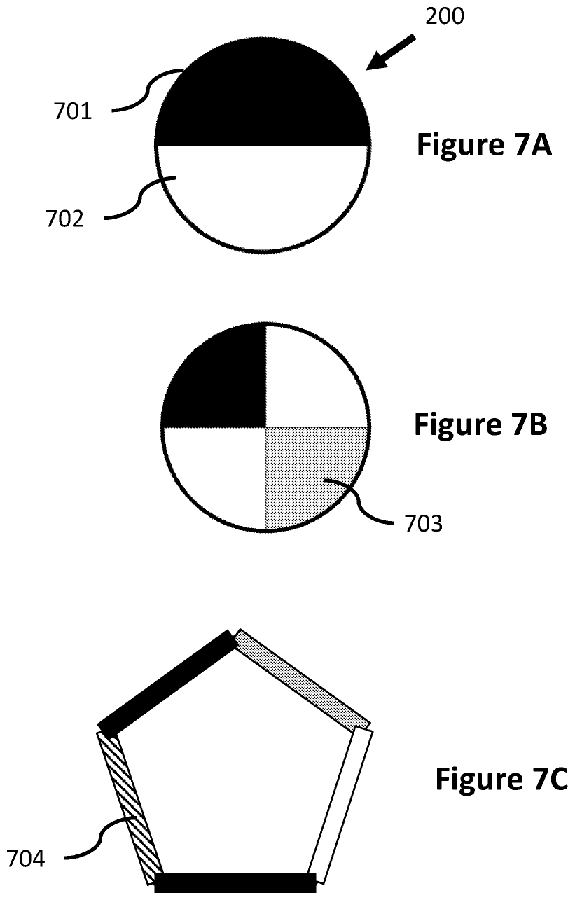

One aim of the manipulation of the rotation of magnetic particles 310 is to provide a platform to change the appearance of a surface. For example, in FIG. 5, the external field 501 manipulates the shading of the array 500 wherein some pixels are black, grey and white. FIG. 7 provides some examples of how a magnetic particle 310 can be shaded, colored or patterned on its surface. The surface of the magnetic particles can be patterned with pre-existing images, for example: emojis, symbols or icons. FIG. 7A shows a 2D representation of a 3D sphere magnetic particle 200 which is shaded black 701 on one side and white 702 on the other side. Such a magnetic particle 200 rotating within a hole can be viewed as either black or white, depending on its rotational position within the hole that it resides. Therefore, the magnetic particle 200 of FIG. 7A acts as a black/white pixel on the surface of a magnetic device. It should be noted that any color indicator can be disposed on the surface of a magnetic particle 200. For simplicity, “shading”, “color” and “patterning” are used interchangeably when referring to a visual indicator disposed on a magnetic particle. Therefore, as used herein, “color indicator” may refer to any shade, color, pattern or image on at least part of the surface of a magnetic particle. In some embodiments, the color indicator is viewed under a particular light frequency e.g., UV light. In some embodiments, at least one color indicator is at least partially disposed on the surface of the magnetic particle. In one embodiment, at least one color indicator is at least partially disposed on the surface of the core or the surface of the shell (or a magnetic particle) or a combination thereof. The color indicator disposed on a surface may comprise any color in the visible spectrum. In some embodiments, the color indicator comprises a material which exhibits a property selected from: photochromic, thermochromic, electrochromic, fluorescent, iridescent and phosphorescent or any combination thereof. The color indicator may be greyscale.

FIG. 7B shows a 2D representation of a 3D sphere magnetic particle 200 which is shaded black 701 on one quarter of its surface, grey 703 on another quarter and white 702 on two other quarters. FIG. 7C shows a 2D representation of a pentagon where two sides are shaded black 701, one side is shaded grey 703, one side is shaded white 702 and one side is patterned 704. Although this is a 2D representation of a pentagon, the principle extends to 3D where each side (or facet) is shaded with various colors, shades, patterns, or images.

The magnetic device and magnetic device assembly can both be coupled to additional layers for a variety of applications. For example, and in some embodiments, the magnetic device may further comprise an encapsulation layer which is at least partially disposed on the upper plane or lower plane or a combination thereof. The encapsulation layer protects the magnetic device whilst enabling the magnetic particles to rotate.

Furthermore, the magnetic device and magnetic device assembly can both further comprise an adhesive layer. This enables the magnetic device to be incorporated onto other pre-existing surfaces, such as the body of a vehicle. In one embodiment, the adhesive layer is at least partially disposed on the upper plane or lower plane or a combination thereof. In some embodiments, the adhesive layer is selected from: glue, double-sided tape, command strips, suction cups, magnets and hook-and-loop fasteners (Velcro) or any combination thereof.

### Systems Incorporating Magnetic Devices and External Fields

The magnetic devices and assemblies described herein can be connected to external fields to control and manipulate the orientation of magnetic particles. Thus, the magnetic devices and related assemblies can all be incorporated in a system that enables the control and manipulation of magnetic particles. For example, when a magnet is placed in close proximity to a magnetic device the magnetic particle rotates. The efficiency with which the magnetic particle rotates will depend on the strength of the fields (e.g., magnets) used, the proximity of an external magnet to the magnetic core (i.e., coupling), shielding between various media disposed between the core magnet and the external magnet, polarization of the field, etc. Such a system is designed to manipulate the magnetic particles' rotation in the holding matrix and change the appearance of pixels on a surface e.g., in a single magnetic device or an assembly of devices. As such, and in some embodiments, it is referred to herein as a “magnetic surface-manipulating system” since it comprises a system which changes the appearance of a surface.

In one embodiment, a magnetic surface-manipulating system comprises:
a magnetic device as disclosed herein;
an external field source providing an external field; wherein the external field is configured to control the rotation of magnetic particles.

In one embodiment, the external field is selected from: magnetic, electric or a combination thereof.

In one embodiment, a magnetic surface-manipulating system comprises:
a plurality of magnetic devices, forming a connected structure;
an external field source providing an external field; wherein the external field is configured to control the rotation of magnetic particles.

In one embodiment, a magnetic surface-manipulating system comprises:
a plurality of magnetic devices, forming a connected structure;
at least one an external field source providing at least one external field; and
a controller;
   wherein the controller configures the at least one external field to control the rotation of magnetic particles.

In one embodiment, the system further comprises additional components selected from: a controller, magnet, electromagnet, display monitor, wireless module, power source, battery, generator, electrical cables, data cables, switches, capacitors, inductors, diodes, LEDs, transistors, integrated circuits, sensors, actuators, antennas, amplifiers, fuses, voltage regulators, sockets, electrical ports, solenoids and RF modules or any combinations thereof.

As used herein an “external field source” refers to any device, machine or source that provides an external field. In one embodiment, the external field is a magnetic field or an electric field or a combination thereof.

In some embodiments, the plurality of magnetic devices which form a connected structure are connected by connectors, as disclosed herein. In some embodiments, some of the magnetic devices in the connected structure are connected by electric wires. For example, a first connected structure is connected to a second connected structure by an electric connection, such that the two connected structures receive the same signal, but are laterally separated. In such an example, several connected structures may be located at different places on a pre-existing body (e.g., a vehicle) but receive the same input from a centralized controller.

The “control over the rotation” of the magnetic particles, by means of the external field, is defined as one that moves the particles even nominally within the hole that it is secured in the holding matrix. Primarily the external field will make the magnetic particles rotate, however, the motion of the magnetic particles is not limited to rotation alone. Thus the term “rotation”, in some embodiments, includes lateral and vertical motion as well. For example, when holes are elongated shapes, magnetic particles will move laterally along those shapes. As stated elsewhere herein, magnetic particles are secured within the upper and lower planes of a holding matrix, typically by holes aligned between the upper and lower plane. However, in some embodiments, only one of the planes has holes, whereas the other plane has a well, indentation, trough or trench which secures the magnetic particle in place. Furthermore, since the magnetic particles can come in many 3D structures, the external field not only rotates the magnetic particles, but they can also move at least partially laterally and at least partially vertically inside the holes of the holding matrix. For example, whereas a sphere may not move laterally and/or vertically when held in a circular hole (due to its geometric conformation within the circular hole), a dodecahedron (12 sides) may not only rotate within the hole, it may move laterally and/or vertically, depending on its orientation within the hole. As such, some hole/magnetic-particle shape combinations may provide more prevalent orientations than others, within the holding matrix. Thus, giving rise to some pixel colors being more prevalent than others, depending on the surface coloration/shading of the magnetic particles.

In some embodiments, the connected structure is flexible or curved.

In some embodiments, the external field is provided by an electromagnet, a permanent magnet or a combination thereof. In some embodiments, the external field is provided by an electric field.

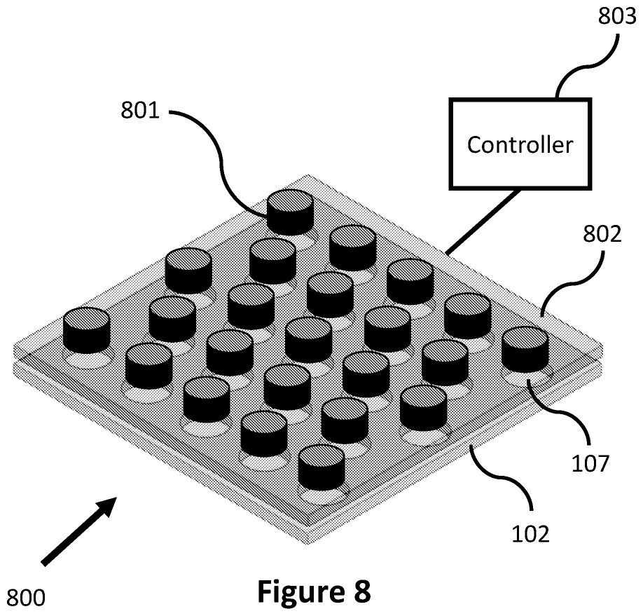

FIG. 8 shows a schematic of part of the magnetic surface-manipulating system 800. In one embodiment, an array of external (electro)magnets 801 are coupled to the lower plane 102 of the magnetic device structure. The magnets 801 are positioned above the holes in the lower plane 102. The magnets 801 are in close enough proximity to the magnetic particles (not shown) so as to effect a rotational change in the corresponding magnetic particles in the array. A connecting medium 802 forms a base whereupon a plurality of magnets 801 are connected and disposed thereon. Connections between the plurality of magnets 801 is carried out by electrical circuitry. In one embodiment, the connecting medium 802 comprises: a printed circuit board (PCB), breadboard, perfboard and stripboard or any combination thereof. In one embodiment, the connecting medium 802 is connected to the lower plane 102 via additional layers, for example an adhesive. In one embodiment, the connecting medium 801 is coupled to the lower plane by a connector. Non-limiting examples of connectors between the connecting medium 801 and the lower plane 102, are selected from: physical connection clips, snap-fit connectors, interlocking connectors, screw connections, clamps, rivet connectors, adhesive and springs or any combinations thereof.

In one embodiment, where at least one external field is provided by an array of electromagnets disposed on the upper plane or lower plane, the array of electromagnets being in close proximity to the magnetic particles, the electromagnets are configured to rotate the plurality of magnetic particles within the holes by application of an external magnetic field.

In one embodiment, a single electromagnet is used to manipulate the orientation of the magnetic particles in the magnetic device. In a further embodiment, the system further comprises a system which moves the location of the electromagnets, such as a motorized system containing tracks. In on embodiment the system further comprises a controller 803 configured to control various inputs (e.g., current, voltage) to the electromagnets. In one embodiment, the system further comprises a power supply (not shown) configured to supply power to the system. The controller is also configured to be programmable such that a particular sequence of input and output signals can be selected, read and analyzed. In one embodiment, the system further comprises a display system configured to display information related to the magnetic devices, and related systems, disclosed herein.

The magnetic surface-manipulating system can be used to write or draw an image or text on a surface by the manipulation of pixels. As such, the plurality of external magnets 801 can be programmed to draw letters, numbers, icons or patterns on a surface. This is done by application of a magnetic field, which rotates the magnetic particles such that they display color/shaded pixels, as viewed from one side of the magnetic device. In one embodiment, particular voltages (or currents) are chosen to correspond to particular orientations of magnetic particles and thus to appear as specific pixel colors.

In one embodiment, the system comprises at least one external magnet both above and below the upper and lower planes, respectively. For example, an electromagnet is disposed on the lower plane and is used to ‘reset’ the orientation of the magnetic particles, whereas a mobile magnetic ‘pen’ (also represented as an external magnet 501 in FIG. 5) can be brought into close proximity of the upper plane of the magnetic device to write or draw on the surface, by manipulating the orientation of the magnetic particles. Once the user is finished drawing with the mobile magnetic ‘pen’, the electromagnet, or electromagnets, on the lower plane of the magnetic device can reset the magnetic particles to their original state i.e., erasing the drawn image.

In one embodiment, the controller is further configured to provide inputs to the plurality of electromagnets 801 in a sequential order i.e., in time. In this way, images, patterns and words (or other), constructed of pixels that change in time, creates the effect of a moving image. This has one application in display boards or advertising.

In one embodiment, the plurality of magnets 801 is fixed in place. In another embodiment the magnets 801 are moveable.

### Methods of Operating a Device and Related Systems

The magnetic devices, related arrays and related systems (e.g., the magnetic surface-manipulating system) can all be incorporated into a system comprising various components to enable the movement of magnetic particles. The main principle of operation involves manipulation of magnetic particles by external fields e.g., magnetic or electric, or both. As such the method of operating magnetic devices extends to operating their related arrays and related systems.

In one embodiment, the method of operating a magnetic device comprises.
applying an external magnetic field in proximity to the plurality of magnetic particles, the plurality of magnetic particles comprise at least one color indicator at least partially disposed on the surface of the magnetic particle;
thereby rotating the plurality of magnetic particles; and
wherein the rotating causes the at least one color indicator to become viewable from above the upper plane or below the lower plane, or a combination thereof.

In one embodiment, the method of operating a magnetic device comprises.
applying an external magnetic field in proximity to the plurality of magnetic particles, the plurality of magnetic particles comprise at least one color indicator at least partially disposed on the surface of the magnetic particle;
thereby rotating the plurality of magnetic particles such that when the external magnetic field is removed, the orientation of the plurality of magnetic particles remains fixed; and
wherein the rotating causes the at least one color indicator to become viewable from above the upper plane or below the lower plane, or a combination thereof.

In some embodiments, the polarity of the external magnetic field can changed from north to south. This can be controlled by changing the voltage (or current) of a power source from positive to negative, for an electromagnet. In some embodiments, the terms “external field”, “external magnetic field” and “external electric field” are used interchangeably. Since any external field can be used, particular examples referring to one type of external field should not be considered a limiting case. In some embodiments, the polarity of the electric field can be changed from positive to negative. In some embodiments, the orientation of the external field changes to enable the movement, e.g., rotation, of magnetic particles.

### Method of Fabricating Magnetic Devices and Associates Arrays of Devices

The principle structure of the magnetic device comprises magnetic particles within a holding matrix. The magnetic particles comprise a core and a shell or a core with an encapsulation material disposed thereon. The holding matrix comprises an upper plane and a lower plane. The holding matrix may additionally comprise spacers.

The following non-limiting list of processes are incorporated into the method of fabricating the shell: imprinting, rolling, dripping, cutting, molding, and etching said shell to comprise said core cavity or any combinations thereof. In some embodiments, the mold comprises a shape corresponding to any of the shapes disclosed herein. Shell structures can be made in their entirety in a single step with one structure, or as an assembly of more than one structure e.g., two half shells or multiple shell sections being assembled together. For example, two half-shell structures incorporating a core cavity can be assembled together forming the full-shell structure. The multiple shell structures can be assembled by: adhesive material, glue, pinned, welded, pressed, heat-pressed and, held together by further encapsulation material.

In some embodiments, the core cavity can be further fabricated by any of the following processes selected from: drilling, 3D printing, molding, melting, solidifying, imprinting and etching or any combinations thereof. In some embodiments, the molds are configured to provide sections of the shell structure such that components of the shell can be assembled together.

Magnetic materials, such as magnetic or ferromagnetic, used in magnetic cores can be manufactured by standard means. Methods to manufacture small magnetic cores can comprise any of the following processes selected from: grinding, milling, mixing and melting, pressing, sintering, and machining or any combinations thereof. For example, typical neodymium magnets comprise neodymium, iron and boron in a pure form. These components are then mixed and melted in a furnace. The mixture is heated above the melting point and the raw materials form a metal alloy. Once the alloy has been created it is cooled and crushed into a fine powder in a milling machine. The magnetic powder is then pressed into a mold using a hydraulic press, in some embodiments. In some embodiments, the mold comprises a shape corresponding to any of the shapes disclosed herein. The mold is designed to form the magnet into any of the shapes and sizes disclosed herein. The pressed magnet is then sintered, causing the magnetic fragments to fuse to form a solid magnet. Finally, the magnet is machined to the desired dimensions and shape.

In some embodiments, magnetic cores are inserted into manufactured cavities within the shells. The core and shell can be held together by adhesives, pins or other forms of restraining means.

In some embodiments, the shell is formed around the core. In other embodiments the core is inserted into a cavity-comprising shell.

In its simplest form the holding matrix comprises an upper and lower plane, one or both of which comprise an array of holes. In some embodiments, the holding matrix comprises any of the following: plastic, polymer and dielectric or any combinations thereof. In some embodiments, the upper and lower plane comprise the same material. In other embodiments, the upper and lower plane comprise different materials. In some embodiments, the holding matrix is manufactured by any of the following processes, selected from: 3D printing, molding, imprinting, rolling, drilling, cutting and etching or any combinations thereof. In other embodiments the holding matrix is manufactured by any of the following processes, selected from: injection molding, blow molding, thermoforming, compression molding, transfer molding, casting, foaming, extrusion and rotational molding or any combinations thereof. In some embodiments, the upper plane or lower plane or a combination thereof are fabricated by any of the following processes selected from: 3D printing, molding, imprinting, rolling, drilling, cutting, molding, etching, molding, injection molding, blow molding, thermoforming, compression molding, transfer molding, casting, foaming, extrusion and rotational molding or any combinations thereof.

In some embodiments, the holes in the upper and lower planes of the holding matrix are manufactured using any of the following processes: drilling, punching, milling, laser cutting, waterjet cutting, ultrasonic welding and cutting, electrical discharge machining, routing, plasma cutting, die cutting and etching or any combination thereof.

Magnetic particles are secured within holes or openings between the upper and lower planes of the holding matrix. Distribution of such magnetic particles can be carried out by dispersing (e.g., pouring) a batch of magnetic particles onto the upper or lower planes of the holding matrix, which comprise holes, shaking or vibrating the same until the magnetic particles are secured within the holes of either the upper or lower plane of the holding matrix. In some embodiments, the pouring of a batch of magnetic particles is carried out when magnetic particles are in a liquid medium. In some embodiments, the liquid medium is removed once the magnetic particles are in place. In some embodiments, the removal of the liquid medium is carried out by any of the following selected from: drying, heating, vacuum pumping and exposure to gas flow or dry box or any combinations thereof. Alternatively, the upper and lower plane can be loosely pressed together, with a batch of magnetic particles being inserted therebetween, lightly shaking the loose assembly and slowly pressing the upper and lower plane together until all the holes are occupied with magnetic particles. In another embodiment, magnetic particles can be individually placed within the holes in the holding matrix, or placed in batches. Similar methods are used in automated liquid droppers, liquid handling robots, or liquid handling systems to place precise liquid volumes in an array of receptacles. Thus, In some embodiments, robotic systems are used to place magnetic particles in holes within the holding matrix. In one embodiment, pick-and-place robots or pick-and-place systems are used to place the magnetic particles in holes of the holding matrix. In one embodiment, distribution of magnetic particles comprises placing the magnetic particles in holes by a pick-and-place system.

An assembled device can be further encapsulated within an encapsulation material using standard encapsulation methods. In one embodiment, the method further comprises an encapsulation at least partially disposed above said upper plane or below said lower plane or a combination thereof.

In some embodiments, the assembly is placed into another matrix and configured to adjust a variety of properties or secure and fine-tune motion of the particles in the array.

In one embodiment, the term “a” or “one” or “an” refers to at least one. In one embodiment, the phrase “two or more” may be of any denomination, which will suit a particular purpose. In one embodiment, “about” or “approximately” may comprise a deviance from the indicated term of +1 %, or in some embodiments, −1 %, or in some embodiments, ±2.5 %, or in some embodiments, ±5 %, or in some embodiments, ±7.5 %, or in some embodiments, ±10 %, or in some embodiments, ±15 %, or in some embodiments, ±20 %, or in some embodiments, ±25 %.

Those skilled in the art to which this invention pertains will readily appreciate that numerous changes, variations, and modifications can be made without departing from the scope of the presently disclosed subject matter, mutatis mutandis.

1. A magnetic device comprising:
a plurality of magnetic particles, said magnetic particles comprising a core and a shell; and
a matrix comprising an upper plane and a lower plane each comprising an array of placeholders which are aligned between said upper plane and said lower plane;
wherein said plurality of magnetic particles is secured in between said upper plane and said lower plane within said array of placeholders.

2. The device of claim 1, wherein said core has a shape selected from a list comprising:
random shape, sphere, cylinder, tetrahedron, cube, octahedron, dodecahedron, icosahedron, cone, pyramid and rod or any combinations thereof.

3. The device of claim 1, wherein said shell has a shape selected from a list comprising:
random shape, sphere, cylinder, tetrahedron, cube, octahedron, dodecahedron, icosahedron, cone, pyramid and rod or any combinations thereof.

4. The device of claim 1, wherein said core comprises between 1 to 99% of the volume of said magnetic particle.

5. The device of claim 1, wherein said core comprises a magnetic material.

6. The device of claim 5, wherein said magnetic material comprises: permanent magnet, ferromagnet, iron, aluminum, cobalt, nickel, gadolinium, dysprosium, neodymium, samarium, terbium, molybdenum, copper, europium, holmium, ceramic magnet and alnico magnet or any combinations thereof.

7. The device of claim 6, wherein said ceramic magnet comprises: strontium ferrite, barium ferrite, titanium ferrite, yttrium ferrite, yttrium iron garnet and lithium ferrite or any combination thereof.

8. The device of claim 1, wherein said shell or said upper plane, or said lower plane, or any combination thereof, comprise a polymer.

9. The device of claim 8 wherein said polymer is selected from: polyethylene (PE), polypropylene (PP), polyvinyl chloride (PVC), polystyrene (PS), polyethylene terephthalate (PET), polytetrafluoroethylene (PTFE), nylon, polycarbonate (PC), acrylonitrile-butadiene-styrene (ABS), polyurethane (PU), polyvinylidene fluoride (PVDF), perfluoroethylene (PFE), polymethyl methacrylate (PMMA), polyimide (PI), polyphenylene oxide (PPO), polyphenylene sulfide (PPS), polyetheretherketone (PEEK) and silicone or any combinations thereof.

10. The device of claim 1, wherein said shell comprises a metal.

11. The device of claim 10, wherein said metal is selected from: copper, titanium, tungsten, 416 stainless steel, nitinol, and an alloy or any combination thereof.

12. The device of claim 1, wherein the size of at least one dimension of said magnetic particles ranges from between 0.01 to 5 mm.

13. The device of claim 1, wherein said magnetic particles further comprise at least one coating disposed thereon.

14. The device of claim 1, wherein the thickness of said upper plane, or said lower plane, or a combination thereof, ranges between 0.01 to 5 mm.

15. The device of claim 1, wherein said upper plane, or said lower plane, or a combination thereof, is transparent, translucent, or opaque.

16. The device of claim 1, wherein said upper plane, or said lower plane, or a combination thereof at least partially reflect, absorb, or polarize incident light.

17. The device of claim 1, wherein the placeholders in said array of placeholders are selected from: a hole, an indentation, or a combination thereof.

18. The device of claim 17, wherein the shape of the placeholders in said array of placeholders is selected from: random shape, circle, square, rectangle, triangle, rhombus, parallelogram, trapezoid, pentagon, hexagon, heptagon, octagon, nonagon, decagon, oval, ellipse, kite, elongated shape and diamond or any combination thereof.

19. The device of claim 1, wherein said array of placeholders are positioned in a honeycomb structure.

20. The device of claim 1, wherein the distance between adjacent placeholders in said array of placeholders ranges between 0.01 to 10 mm.

21. The device of claim 1, wherein said upper plane and said lower plane are curved.

22. The device of claim 1, wherein said plurality of magnetic particles protrude out of said upper plane or said lower plane or a combination thereof, by a percentage volume of said magnetic particles ranging between 1 to 50%.

23. The device of claim 1, further comprising spacers between said upper plane and said lower plane.

24. The device of claim 1, further comprising at least one color indicator at least partially disposed the surface of said core or said shell or a combination thereof.

25. The device of claim 24, wherein said color indicator comprises a material which exhibits a property selected from: photochromic, thermochromic, electrochromic, fluorescent, iridescent, and phosphorescent or any combination thereof.

26. The device of claim 1, wherein said plurality of magnetic particles are configured to rotate within said placeholders by application of an external field.

27. The device of claim 1, further comprising an encapsulation layer at least partially disposed on said upper plane or said lower plane or a combination thereof.

28. The device of claim 1, further comprising an adhesive layer at least partially disposed on said upper plane or said lower plane or a combination thereof.

29. The device of claim 1, wherein the area of said matrix ranges between 1 cm² to 10 m².

30. The device of claim 1, further comprising a plurality of connectors configured to connect more than one of said matrix together.

31. A magnetic device assembly comprising a plurality of the device of claim 29 wherein said plurality of connectors connects said plurality of devices.

32. A magnetic surface-manipulating system comprising:
a plurality of the devices of claim 1, forming a connected structure;
at least one an external field source providing at least one external field; and
a controller;
wherein said controller configures the at least one external field to control the rotation of magnetic particles.

33. The system of claim 32, wherein said at least one external field is selected from:
magnetic, electric or a combination thereof.

34. The system of claim 32, wherein said connected structure is flexible.

35. The system of claim 32, wherein said at least one external field is provided by an electromagnet, or a permanent magnet or combinations thereof.

36. The system of claim 32, wherein said at least one external field is provided by an array of electromagnets disposed on said upper plane or said lower plane, said array of electromagnets being in close proximity to said magnetic particles, wherein said electromagnets are configured to rotate said plurality of magnetic particles within said placeholders by application of an external magnetic field.

37. A method of operating the device of claim 1, said method comprising:
applying an external magnetic field in proximity to said plurality of magnetic particles, said plurality of magnetic particles further comprise at least one color indicator at least partially disposed the surface of said magnetic particles;
thereby rotating said plurality of magnetic particles; and
wherein said rotating causes said at least one color indicator to become viewable from above the upper plane or below the lower plane, or a combination thereof.

38. The method of claim 36 wherein when said external magnetic field is removed, the orientation of said plurality of magnetic particles remains fixed.

39. A method of fabricating the device of claim 1, said method comprising:
fabricating said shell comprising a core cavity within said shell;
fabricating said core wherein said core is disposed within said core cavity, forming magnetic particles;
fabricating said matrix comprising said upper plane and said lower plane each comprising an array of placeholders;
disposing spacers between said upper plane and said lower plane; and
distributing said magnetic particles within said matrix wherein said magnetic particles are secured inside said array of placeholders.

40. The method of claim 39, wherein said fabricating of said shell comprises: imprinting, rolling, dripping, cutting, molding, and etching said shell to comprise said core cavity or any combinations thereof.

41. The method of claim 39, wherein said shell comprises more than one section wherein said more than one section adhere to one another forming said shell comprising a core cavity.

42. The method of claim 41, wherein said adhering comprises means selected from: adhesion with an adhesive material, glue, pinning, welding, pressing, heat-pressing, and holding together with an encapsulation material.

43. The method of claim 39, wherein said core is fabricated by the processes selected from: grinding, milling, mixing and melting, pressing, sintering, and machining or any combinations thereof.

44. The method of claim 39, wherein said fabricating upper plane or said lower plane or a combination thereof comprises: 3D printing, molding, imprinting, rolling, drilling, cutting, etching, injection molding, blow molding, thermoforming, compression molding, transfer molding, casting, foaming, extrusion and rotational molding or any combinations thereof.

45. The method of claim 39, wherein said fabricating of placeholders comprises: drilling, punching, milling, laser cutting, waterjet cutting, ultrasonic welding and cutting, electrical discharge machining, routing, plasma cutting, die cutting and etching or any combination thereof.

46. The method of claim 39, wherein said distributing comprises dispersing said magnetic particles on said upper plane or said lower plane and vibrating said upper plane or said lower plane.

47. The method of claim 39, wherein said distributing comprises placing said magnetic particles in said placeholders by a pick-and-place system.

48. The method of claim 39, further comprising an encapsulation at least partially disposed above said upper plane or below said lower plane or a combination thereof.

49. The method of claim 39, further comprising an adhesive material at least partially disposed above said upper plane or below said lower plane or a combination thereof.
